(19) United States
(12) Patent Application Publication
(10) Pub. No.: US 2012/0031157 A1
(43) Pub. Date: Feb. 9, 2012

(54) SOIL HEALTH REJUVENATOR AND ORGANIC MATTER ENHANCER

(76) Inventor: Sitaram Prasad Paikray, New Delhi (IN)

(21) Appl. No.: 13/265,279

(22) PCT Filed: Apr. 20, 2010
(86) PCT No.: PCT/IB10/51737

§ 371 Date: Oct. 19, 2011

(30) Foreign Application Priority Data
Apr. 22, 2009 (IN) 834/DEL/2009

(51) Int. Cl. C05F 11/08

(52) U.S. Cl. 71/7; 71/6

(57) ABSTRACT

The invention relates to a composition which is suitable for use as a soil conditioner or fertilizer. The soil health rejuvenator in the present invention is developed to provide soil conditioning which increases organic matter content of the soil and develop immunity in plants to fend off pest and disease. Moreover, the invention developed herein also reduces the harmful effect of chemicals accumulated in soil after prolonged exposure of chemical fertilizers in soil, improving soil physico-chemical properties. The invention provides the solution of sustainable agriculture by reducing the health hazardous caused by the extensive use of chemical amendments.

### FIELD OF THE INVENTION

The present invention relates to the composition comprises of viable cells of microorganisms with bio-decomposition and rejuvenation property enhancing organic matter in agricultural soil which thereby enhances crop productivity and develop immunity towards plant diseases.

In particular, the invention relates to a composition and method thereof, which is suitable for use as a soil conditioner or fertilizer. The soil health rejuvenator in the present invention is developed to provide soil conditioning to reduce harmful effect of chemicals accumulated in soil after prolonged exposure of chemical fertilizers and to improve soil physico-chemical properties, increasing organic matter.

### BACKGROUND OF THE INVENTION

In general, contaminants in the environment are exposed to chemical and biological degradation. However, some contaminants are chemically stable. Therefore, intrinsic degradation is frequently dependent upon the biological activity of the indigenous microbial population. In most environments, a large variety of microorganisms is present at relatively high population densities.

Although green revolution has increased agricultural productivity for a while, this has again stagnated afterwards due to the use of extensive chemical fertilizer deteriorating the soil health leading towards low productivity of agriculture produce. To improve agricultural productivity, most of the farmers use chemicals to fertilize plants and to fight pests and diseases. Many of these chemicals actually destroying beneficial soil microorganisms and can damage a plant's natural ability to fend off pests and diseases. Additionally, chemical fertilizers can build up in the soil and eventually reduce the overall productivity of the soil. Our plants become weaker and weaker in the process, realizing the use of soil conditioning using microorganisms.

Plant growth and crop productivity is dependent mainly on the soil physical condition. Characteristics of the good soil are high water intake capacity and movement, plant growth development and aeration of the soil. The soil characteristics can be improved in part through the use of good management practices. Moreover, the amendment of soil with microorganisms containing the potential to decompose soil organic matter promoting plant growth by producing metabolites, increasing water retention capacity of the soil and by bio-decomposition can also improve the soil physical condition. The improvement in soil texture and thereby soil physical property is termed as soil conditioning.

Organic contents of the soils are constantly reduced by extensive use of chemical fertilizer and repeated farming which leads to hard soil. Further, soil particles become compact and are not able to retain nutrients and moisture due to repeat and overuse of chemical fertilizers. This vicious circle continues when greater amount of chemical fertilizer are required to supplement mineral ions and macro nutrients which are gradually lost. Other than possibility of containing non-biodegradable components from manufacturing process, chemical fertilizers do not improve condition of hard on soil.

Intensive use of chemical fertilizer is the major cause of imbalance infusion of several micro and macronutrients in soil and has deteriorated soil health, which ultimately resulted in low productivity and stagnancy in agriculture growth.

The major cause of concern towards this low productivity and stagnancy in agriculture growth is the imbalanced infusion of several micro and macro nutrients which are essential for plant growth. For optimum plant growth, nutrients must be available in sufficient and balanced quantities. Excessive and exclusive dependence on nitrogenous and phosphatic fertilizers is very harmful to the soil. As a result, overall agricultural productivity is bound to decline.

The constant assault on the land and soils by agricultural and horticultural chemicals is proving to be a major problem, causing imbalances in the amount of essential nutrients in those soils. Thus, the soils are often rendered unsuitable for economically sustained farming and at times the soils have been denatured such that normal levels of plant life cannot be supported.

A wide variety of soil conditioners, which claim to improve a number of soil physical properties are available commercially in the market. However, the successful application and broad spectrum activity of the product is the major issue of concern.

U.S. Pat. No. 3,766,685 discloses a Soil conditioner produced by fermentation of used tire mesh to produce an oxygen enriched product integrally bonded to the mycelium produced by the fermentation organism Fungi imperfecti.

U.S. Pat. No. 6,752,850 discloses liquid soil conditioning composition of an aqueous dispersion of rock lime and sulfur to improve the agricultural productivity of clay soils.

U.S. Pat. No. 4,985,060 discloses a soil conditioner consists essentially of inorganic materials and, according to need, may contain microorganisms capable of eliminating detrimental effects of harmful microorganisms more effectively from the rhizosphere of a crop.

U.S. Pat. No. 5,733,355 discloses bacterial preparation with the ability to produce lipopeptide and cellulosic compounds. The preparation comprised of Members of genus Bacillus and Clostridium.

Likewise several other patents on soil conditioner have disclosed the soil conditioners. However these are quite different from the applied soil conditioner of the present application.

In spite of all the effort and money being spent, no technology has yet been evolved which is economically satisfactory.

There is a need for environmentally friendly and acceptable soil improver compositions and fertilizers which are able to ameliorate soils by providing a natural source of NPK as well as other essential minerals and trace elements. It is desirable to create more favorable mediums for plant growth and to conserve soil by improving or increasing soil pH, water-holding capacity, water infiltration rates, aeration and temperature whilst being environmentally acceptable. It is also desirable to provide more or better alternatives to current soil treatments.

Thus, in view of the above prior art, the present invention disclosure provides a method for conditioning composition which is utilized, for instance, as a soil conditioner, fertilizer or a fertilizer-like product. Further, the present invention is subjected to the development of microorganisms based conditioner this will increase organic matter of the soil improving physical and nutritional status making it more fertile.

### OBJECT OF THE INVENTION

The main objective of the present invention is to develop a soil bio-conditioner using microorganisms reducing the harmful effect of chemical amendments. The soil conditioner in study will improve the organic carbon content which thereby improves soil fertility and crop productivity with reduced cost of cultivation.

Another object of the present invention relates to the strains, finally selected are a mixture of fungi and bacteria. Of which fungi are mainly responsible for bio-decomposition of plant litter increasing organic carbon content and bacteria are with the property of plant growth promotion. Altogether the consortium developed in the present study is a soil bio-conditioner with plant growth promoting properties.

It is another object of the present invention to provide a soil improver composition of microorganisms which ameliorate soils by providing a natural source of NPK as well as other essential minerals and trace elements

Yet another object of the present invention relates to a method, make it more cost effective the soil microbial consortium (In-Soil-Culture), one to two units of consortium per hectare will be required for normal land, which will reduce the cost of application and can be easily affordable by the poor Indian farmers.

Another object of the present invention relates to the selection and optimization of microorganism for the development of an efficient and broad-spectrum consortium with plant residual matter decomposition.

Still another object of the present invention is to loosen the soil, which allows the roots to penetrate the soil more efficiently.

Still another object of the present invention relates the organisms in the present consortium also enhance the nutrient cycling to make available micro and macronutrient to the plant.

Still another object of the present invention relates the composition is optimally formulated to provide a high cfu bacterial population with longer shelf life while maintaining the easy usability and handling of agriculturally important microbial bioinoculant.

Still another object of the present invention relates to provide organisms that were selected and optimized to work in diverse agro-climatic condition.

### SUMMARY OF THE INVENTION

The plant productivity, crop yield and soil health are directly related with each other. An organic matter deficient soil cannot produce better crop and plant, and considered as less fertile. Soil fertility can be improved by improving soil physical properties.

The subject invention pertains to, develop a soil bio-conditioner using microorganisms reducing the harmful effect of chemical amendments. The soil conditioner in study will improve the organic carbon content which thereby improves soil fertility and crop productivity with reduced cost of cultivation.

Further, the subject invention provides benefits to farmers by reducing dependency on chemical fertilizers which are comparatively costly and deteriorating soil health. In addition, the invention also pertains to the rejuvenation of soil for sustainable production without incremental cost and also reduced (15-20%) water requirement for irrigation.

Additionally, this soil conditioner may contain a microorganism having the function of competing with the harmful microorganisms present in the soil or utilizing them as nutrient sources to eliminate the detrimental effects thereof.

Still another advantage of the present invention is that the fertilizer loosens the soil, which allows the roots to penetrate the soil more efficiently.

Significantly, these benefits to plants are obtained without any hazardous side effects to human and environment.

Further aspects of the invention will become apparent from consideration of the ensuing description of further embodiments of the invention. A person skilled in the art will realize that other embodiments of the invention are possible and that the details of the invention can be modified in a number of respects, all without departing from the inventive concept. Thus, the following descriptions are to be regarded as illustrative in nature and not restrictive.

### DETAILED DESCRIPTION OF THE INVENTION

Accordingly, the present invention is directed towards the isolation and screening of microorganisms with the ability of decomposition of plant residual matter and accumulated chemicals present in soil. The selection is also dependent upon the plant growth promoting properties.

To a conditioning composition and a catalyst for use therewith, together with a method for manufacturing the composition. In particular, the invention relates to a composition which is suitable for use as a soil conditioner or fertilizer.

The composting microbes are selected from one or more of bacteria, fungi, yeasts and other such organisms. The bacteria and other microbes suitable for use are nitrogen-fixing, carbon decomposting, phosphorous decomposting, potassium decomposting or yeast growth factor producers commonly known to those skilled in the art. The bacterium for use in the digestion step is preferably selected from one of more natural phospholytic bacteria, nitrogen-fixing bacteria, anaerobic and aerobic bacteria and thermolytic bacteria. Decomposition of the digestion mixture can be maintained by the thermolytic bacteria which stabilizes the heat or temperature of the mixture. The bacteria together with the fungi are able to draw minerals from the composting organic matter to help form the biomaterial. Desirably the bacteria are thermolytic bacteria and gram negative bacteria.

Bacteria and fungal microorganism suitable for use in the present invention preferably are selected from one or more genera of Azotobacter, Bacilla, and Pseudomonas, in addition to specific bacteria and fungi such as Pseudomonas fluorescens, Azotobacter, Bacillus polymyxa, Trichoderma herzianum, Trichoderma viride respectively.

The present invention provides exemplary isolates of soil bacterial strains and fungal strains as described herein.

Specifically, the present invention provides an isolated Pseudomonas fluorescens MTCC 5525 bacterial strain having accession number.

The present invention provides an isolated Bacillus polymyxa MTCC 5528 bacterial strain having accession number.

The present invention provides an isolated Azotobacter sp. MTCC 5529 bacterial strain having accession number.

The present invention provides an isolated Trichoderma herzianum MTCC 5530 fungal strain having accession number.

The present invention provides an isolated Trichoderma viride MTCC 5532 fungal strain having accession number.

The present embodiment of the invention provides an exemplary mixture of fungal isolates having accession number. The present invention provides exemplary soil improver composition, wherein said composition comprises of nitrogen fixing bacteria isolate, a phosphate solubilizing microbe isolate, and a biocontrol microbe isolate. In one embodiment said microbe is selected from the group consisting of a bacteria, fungus or combination thereof.

A soil improver composition useful as bioinoculant, wherein the said composition comprising at least one bacterial and fungal isolate of Pseudomonas fluorescens, Bacillus polymyxa, Azotobacter, Trichoderma herzianum and Trichoderma viride, with an accession number, MTCC 5525, MTCC 5528, MTCC 5529, MTCC 5530, MTCC 5532, respectively and a carrier.

Fungi used in the present invention are preferably one or more of white rot fungi and brown rot fungi. The fungi scavenge phosphorus and strips nutrients from the digesting organic matter. The fungi are believed to concentrate micronutrients as they digest the plant matter and helps form the biomaterial.

To a conditioning composition and a catalyst for use therewith, together with a method for manufacturing the composition. The present invention relates to a soil improver composition which is suitable for use as a soil conditioner or fertilizer.

In an embodiment of the present invention, the group of organisms selected comprised of fungi and bacteria with soil rejuvenation property improving soil organic carbon content and promote plant growth and crop productivity.

In another embodiment of the present invention, soil microbes provide the digestion of organic materials, converting them into a form that can be absorbed by plant roots. Soil microbes are also valuable in stabilizing the soil structure. Soils with poor structure often prevent the necessary amounts of water and oxygen to enter in the interspace of clay particle, thus limiting their availability to plant roots. The improvement in soil conditions is of particular concern of the present invention.

Further, in another embodiment of the present invention, the said microbial consortium is provided in a composition suitable to apply to the soil directly or the soil surrounding the plants. The suitable carrier used in the invention is the inert material, powder. Several components present in the suitable carrier are growth supporting substances and the substances that maintains long shelf life of the microorganisms.

Other suitable additives include buffering agents, wetting agents, coating agents, and abrading agents. These materials can be used to facilitate the process of the present invention.

The present invention provides a method for a conditioning composition and a catalyst for use therewith, together with a method for manufacturing the composition. In particular, the invention relates to a composition which is suitable for use as a soil conditioner or fertilizer, comprising of providing, i) a microbial formulation comprising a microbial soil isolate, wherein said microbial soil isolate is selected from the group consisting of bacterial strain, a Bacillus polymyxa MTCC 5528 bacterial strain having accession number, a Azotobacter sp MTCC 5529 bacterial strain having accession number, an Pseudomonas fluorescens MTCC 5525 bacterial strain having accession number, a Trichoderma viride MTCC 5532 fungal strain having accession number, a Trichoderma herzianum MTCC 5530 fungal strain having accession number, and ii) a plant, and applying soil improver composition to a plant to enhance carbon content.

In accordance with the present invention, the microbial rejuvenator which is useful in wide agriculture usages such as plant growth promotion and to increase soil organic matter and carbon content by increasing decomposition of plant residual matter. The formulation contains the organisms, which has a shelf life of two year with an initial CFU count of 10¹⁰ and after 1 year up to 10⁸.

As employed in this description, the term “Bioinoculants” refers to the population of single/multiple organisms present in a viable form, which increase plant growth and productivity.

In accordance with still another aspect of the present invention, the strain selection was done by soil sampling from the rhizosphere and rhizoplane of the crops grown in 300 clusters of Uttar Pradesh. A total of 300 samples from 300 different clusters were collected. Ten sampling was done from the same field and all the samples were pooled together to make a composite sample. Samples were processed immediately to recover the entire resident microflora. For the isolation, soil plating was done on Nutrient Agar and Potato Dextrose Agar. A total of 1500 bacterial morphotypes was recovered and maintained as pure culture in stabs for routine use and as glycerol stocks for long-term preservation. Moreover, 100 colonies were obtained from PDA. All the fungal colonies were also maintained as pure culture for further analysis.

In accordance with another aspect of the present invention, the decomposition of plant material is a continuous process going on in the soil by the microbes. The increase in organic matter of soil in this way will reduce the side effect of chemical soil amendments and also improve the crop productivity and soil health. The fungal strains were isolated and studied for their biodecomposition property. Out of 25 fungi isolated and morphologically identified, Trichoderma strain was finally selected.

In accordance with still another aspect of the present invention, Trichoderma along with other fungi obtained were then inoculated to wheat stubbles to study their relative efficiencies in biodegradations. Dried pieces of stubbles (25 g) were taken along with 125 ml of sterile distilled water in each 500 ml Erlenmeyer flask, plugged and sterilized. Inoculum of spore suspension (5-10 ml), containing 10⁶-10⁸ spores per ml was added to each flask and thoroughly shaken. A total of five replicates were prepared. A parallel set of control was maintained.

The inoculated flasks were incubated and shaken at two days interval to spread the organisms uniformly. Partially degraded stubbles were taken out from flasks in triplicate at monthly intervals for three months and different constituents of plant tissues viz. lignin, cellulose, nitrogen, soluble nitrogen and soluble carbohydrates were estimated quantitatively. Results were calculated on dry weight basis.

In accordance with yet another aspect of the current invention, several plant growth promotory activities were checked. Out of 1500 strains, four strains were found potential for tested plant growth promotory properties, inhibiting plant pathogens in soil and at the same time either decompose soil residual matter either directly or producing metabolites which catalyze the reaction and or process performed by other organisms of consortium.

In accordance with yet another aspect of the current invention, the organisms selected in the present invention are stress tolerant strains. These all show growth profile under broad range of temperature (15° C. to 45° C.) and pH (5.5 to 8.0). The survival of a strain was studied in both liquid broth and solid agar plates.

Yeasts and moulds will naturally be present in the digestion mixture without the need to specifically add them. However, it is often useful to add yeast in the form of brewers yeast to the digestion mixture to assist in the composting of the plant material. If yeasts are added to the digestion mixture, it is advisable to add molasses or other saccharides to assist in sustaining these microorganisms.

In accordance with still another aspect of the present invention, the method includes, the application procedure was optimized along with dose required for one hectare of land. The fermentation material such as farm yard manure/agricultural waste/organic waste/compost/various types of flours with sugar/jaggery/molasses/sugarcane juice etc, and schedule of the microorganisms was optimized under natural climatic conditions.

### EXAMPLES

The inventions are now described and illustrated with the following non-limiting examples.

Examples 1-3 relate to lignin, cellulose, nitrogen, soluble nitrogen and soluble carbohydrates were estimated quantitatively and Example 4 relate to strains with high activity as plant growth promoters

### Examples 1

Table 1 presents an example of degradation of lignin and holocellulose in wheat stubbles by different fungi including Trichoderma of the present invention

| | | Lignin degradation; Incubation | | | Holocellulose degradation; | | |
|---|---|---|---|---|---|---|---|
| S. | | 1 | 2 | 3 | 1 | 2 | 3 |
| No. | Fungi | month* | months* | months* | month* | months* | months* |
| 1 | Trichoderma herzianum | 20.0 | 30.57 | 48.27 | 45.85 | 59.57 | 68.92 |
| 2 | T. viride | 19.85 | 28.45 | 83.60 | 41.5 | 56.25 | 70.0 |
| 3 | Aspergillus | 15.0 | 8.95 | 10.57 | 20.23 | 35.89 | 50.25 |
| 4 | Penicillium | 4.6 | 7.80 | 9.85 | 18.9 | 25.33 | 42.30 |
| 5 | Mixed of three fungi | 19.05 | 25.93 | 31.89 | 35.5 | 50.85 | 61.25 |
| 6 | Control | 0.65 | 0.65 | 0.65 | 0.40 | 0.40 | 0.40 |

*Mean of five replicates
Lignin and Holocellulose degradation as percent of initial value

### Examples 2

Table 2 presents an example of changes in total and soluble nitrogen content of the wheat stubbles by different fungi including Trichoderma of the present invention

| | | Total nitrogen content; | | | Soluble nitrogen content; | | |
|---|---|---|---|---|---|---|---|
| S. | | 1 | 2 | 3 | 1 | 2 | 3 |
| No. | Fungi | month* | months* | months* | month* | months* | months* |
| 1 | Trichoderma herzianum | 0.98 | 1.20 | 1.50 | 0.290 | 0.185 | 0.129 |
| 2 | T. viride | 1.0 | 1.19 | 1.56 | 0.19 | 0.165 | 0.150 |
| 3 | Aspergillus | 0.80 | 0.89 | 0.953 | 0.90 | 0.083 | 0.081 |
| 4 | Penicillium | 0.84 | 0.94 | 1.03 | 0.075 | 0.073 | 0.070 |
| 5 | Mixed of three fungi | 0.95 | 1.12 | 1.35 | 0.89 | 0.859 | 0.870 |
| 6 | Control | 0.65 | 0.65 | 0.65 | 0.045 | 0.045 | 0.045 |

*Mean of five replicates
Total and soluble nitrogen contents as percent of degraded stubbles

### Examples 3

Table 3: presents an example of changes in soluble carbohydrates content of the wheat stubbles by different fungi including Trichoderma of the present invention

TABLE 3
Changes in soluble carbohydrates content of the wheat stubbles by
different fungi including Trichoderma of the present invention

| | | Soluble Carbohydrate | | |
|---|---|---|---|---|
| | | content; Incubation time | | |
| S. No. | Fungi | 1 month* | 2 months* | 3 months* |
| 1 | Trichoderma | 0.185 | 0.250 | 0.365 |
| | herzianum | | | |
| 2 | T. viride | 0.190 | 0.250 | 0.294 |
| 3 | Aspergillus | 0.112 | 0.129 | 0.190 |
| 4 | Penicillium | 0.142 | 0.169 | 0.160 |
| 5 | Mixed of three fungi | 0.165 | 0.175 | 0.195 |
| | Control | 0.15 | 0.15 | 0.15 |

*Mean of five replicates
Total and soluble nitrogen contents as percent of degraded stubbles

### Examples 4

Table 4 presents example of Strains with high activity as plant growth promoters and Nitrogen-fixer

TABLE 4
Strains with high activity as plant growth promoters and Nitrogen-fixer**

| | | | | | | | | | N₂ |
|---|---|---|---|---|---|---|---|---|---|
| | ‘P’ | | | | | | | | Fixation |
| | Sol^{$} | ‘Sid’ | % Germination | | Root length | | Shoot length | | (mg/gm of |
| Strain ID^{$$} | (cm) | (cm)^{$} | Chilli | Tomato | Chilli | Tomato | Chilli | Tomato | sucrose) |
| PF/EW/01 | ND | 3.2 | 90 | 82 | 78.5 | 100 | 80.9 | 140 | — |
| PF/EW/04 | ND | 3.8 | 95 | 80 | 90.1 | 70.4 | 80.2 | 160 | — |
| PF/EW/05 | ND | 3.9 | 80 | 95 | 85.0 | 112 | 78.4 | 135 | — |
| PF/AG/02 | ND | 4.0 | 85 | 80 | 72.4 | 54.5 | 80.4 | 98.7 | — |
| PF/AG/04 | ND | 4.2 | 95 | 90 | 79.7 | 73.3 | 90.8 | 95.6 | — |
| PF/AG/09 | ND | 5.2 | 85 | 80 | 75.3 | 82.5 | 80.2 | 78.6 | — |
| AT/EW/03 | ND | ND | 85 | 90 | 83.2 | 88.5 | 89.0 | 112 | 12.4 |
| AT/EW/04 | ND | ND | 65 | 95 | 80.9 | 100.0 | 90.3 | 98.9 | 10.9 |
| AT/EW/06 | ND | ND | 95 | 85 | 80.0 | 90.0 | 90.5 | 115.8 | 11.7 |
| AT/AG/02 | ND | ND | 85 | 90 | 75.1 | 54.9 | 101.4 | 126.3 | 11.4 |
| PSB/EW/03 | 3.0 | ND | ND | ND | ND | ND | ND | ND | ND |
| PSB/AG/02 | 3.7 | ND | ND | ND | ND | ND | ND | ND | ND |
| PSB/AG/05 | 3.2 | ND | ND | ND | ND | ND | ND | ND | ND |

*ND: Not Determined
**Only strains with high activity are shown in the Table.
^{$$}Strains coding; PF, P. fluorescens; AT, Azotobacter; PSB, Phosphate solubilizing bacteria
^{$}Sid, Siderophore producers; P-Sol, Phosphate Solubilization

Overall this soil improver composition and process for soil conditioning makes it possible to enhance the soil productivity in a cost effective manner in a global perspective.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

1. A bioinoculant for soil health rejuvenation and organic matter enhancement comprising cells of atleast one purified culture of Bacterial species, at least one purified culture of Fungal species or a combination thereof, a carrier; and an additive; wherein:
i) the said bacterial species is selected from the group consisting of Pseudomonas fluorescens deposited as MTCC 5525, Bacillus polymyxa deposited as MTCC 5528, Azotobacter deposited MTCC 5529;
ii) said Fungal species is selected from the group of Trichoderma herzianum deposited as MTCC 5530 and Trichoderma viride deposited as MTCC 5532.

2. The bioinoculant composition as claimed in claim 1, wherein the said microbial species composition further comprises of but not limited to yeast, white rot fungi and brown rot fungi, any other microbes suitable for use are nitrogen-fixing, carbon decomposting, phosphorous decomposting, potassium decomposting or yeast growth factor producers commonly known to those skilled in the art.

3. (canceled)

4. The bioinoculant composition as claimed in claim 1, wherein the said carrier is selected from the group of but not limited to clay-based soil, sand, minerals, nutrients, manure or manure products, diluents, gelling agents, thickeners, or any other similar carrier known in the art, or a combination thereof.

5. (canceled)

6. (canceled)

7. The bioinoculant composition as claimed in claim 1, wherein the said additive is selected from the group of but not limited to buffering agents, wetting agents, coating agents, and abrading agents.

8. The bioinoculant composition as claimed in claim 1, wherein the said composition comprises the microbial cells in concentration 1×10⁸-1×10⁹ CFU per gram of said carrier.

9. The bioinoculant composition as claimed in claim 1, wherein each bacterial strain is present in said carrier in a concentration ranging from about 1×10⁴ to about 1×10⁹ cells per gram.

10. (canceled)

11. A method for promoting the growth of a plant comprising the step of applying the bioinoculant to a seed of the plant or to the soil in which the plant is growing or to the soil surrounding the plant.

12. The bioinoculant composition as claimed in claim 1, wherein the said composition is optimized to achieve a shelf life of at least 2 years with an initial count of 1×10¹⁰ and up to 1×10⁸ after 1 year at a temperature range of 15° C.- 45° C.

13. The bioinoculant composition as claimed in claim 1, wherein the said carrier is in the form of an inert powder, liquid, aerosol, gel, paste or any other such form.

14. (canceled)

15. (canceled)

16. (canceled)

17. The bioinoculant composition as claimed in claim 1, wherein the composition improves carbon content of the soil.

18. The bioinoculant composition as claimed in claim 1, wherein the composition improves nitrogen fixation in free living environment, phosphorous decomposting, and potassium decomposting of the soil.

19. The bioinoculant composition as claimed in claim 1, wherein the composition improves nutrient cycling.

20. The bioinoculant composition as claimed in claim 1, wherein the composition improves organic matter decomposition.

21. (canceled)

22. The method as claimed in claim 11, wherein effective amount of the bioinoculant is applied to soil to provide a microbial concentration in range of 10⁶ to 10⁸ cfu/g of soil.
